(19) United States
(12) Patent Application Publication
(10) Pub. No.: US 2026/0108904 A1
(43) Pub. Date: Apr. 23, 2026

(54) PAINTING SYSTEM

(71) Applicants: Hyundai Motor Company, Seoul (KR); Kia Corporation, Seoul (KR)

(72) Inventors: Ki Yeob Son, Hwaseong-si (KR); Jae Dong An, Hwaseong-si (KR); Se Hong Oh, Hwaseong-si (KR)

(21) Appl. No.: 19/247,904

(22) Filed: Jun. 24, 2025

(30) Foreign Application Priority Data
Oct. 18, 2024 (KR) 1020240143361
Feb. 6, 2025 (KR) 1020250015225

(51) Int. Cl. B05B 13/02

(52) U.S. Cl. CPC B05B 13/0235

(57) ABSTRACT

A painting system includes a table configured to rotate relative to a base, a rail spaced apart from the table, a spraying arm configured to move along the rail, and a lift disposed at the table and configured to be elevated from the table. The table defines an exhaust port configured to draw air from an upper side of the table to a lower side of the table.

### CROSS-REFERENCE TO RELATED APPLICATIONS

This application claims benefit of priority to Korean Patent Application No. 10-2024-0143361, filed on Oct. 18, 2024, and No. 10-2025-0015225, filed on Feb. 6, 2025, the disclosures of which are incorporated herein by reference in their entirety.

### TECHNICAL FIELD

The present disclosure relates to a painting system capable of painting, for example, an urban air mobility (UAM) vehicle.

### BACKGROUND

Painting systems may be used to paint objects having relatively simple box-type structures, such as automobiles. The box-type objects may generally have flat and wide surfaces, making it relatively easy to perform painting operations using automated robot arms. Objects having simple structures may have fewer surface obstacles, allowing for uniform paint spraying and making it easier to maintain consistent painting quality.

In some cases, objects such as urban air mobility (UAM) vehicles may have complex structure. For example, UAM vehicles may include various structural components such as wings, horizontal stabilizers, vertical stabilizers, and landing gears, and exhibit significant differences in shape and geometric complexity compared to box-type objects. In particular, such structures may have various curvatures and exhibit significant variations in width and thickness depending on a position of the structure.

In some cases, complex shapes may pose limitations in achieving high-quality painting using painting systems. For example, thin and elongated structures, such as wings, make it difficult to maintain an optimal spraying angle and distance, leading to uneven paint quality. In some cases, complex surfaces, such as curved regions or narrow gaps, may prevent paint from properly reaching certain regions, increasing the likelihood of unpainted regions. In some cases, dispersed paint particles may remain suspended inside a painting booth, degrading painting quality or causing the release of hazardous substances externally.

### SUMMARY

The present disclosure describes a paining system that can reduce or prevent interference between an object to be painted and a robot arm, that can prevent malfunctions caused by contamination of a painting system due to sprayed paint, and that can maintain painting quality by preventing paint contamination.

According to one aspect of the subject matter described in this application, a painting system includes a table configured to rotate relative to a base, a rail spaced apart from the table, an arm configured to move along the rail, a spraying device disposed at the arm, and a lift disposed at the table and configured to be elevated from the table, where the table defines an exhaust port configured to draw air from an upper side of the table to a lower side of the table.

Implementations according to this aspect can include one or more of the following features. For example, the table can include a first frame and a second frame spaced apart from the first frame in a radial direction of the first frame, where the second frame is disposed radially inside the first frame. In some examples, each of the first frame and the second frame has a ring structure.

In some implementations, the table can further include a third frame disposed at the first frame, the third frame configured to rotate relative to the first frame in a circumferential direction of the first frame, and a fourth frame coupled to the third frame and configured to rotate relative to the second frame in a circumferential direction of the second frame. In some examples, the lift is one of a plurality of lifts including a first lift disposed at the third frame, a second lift disposed at a first side of the fourth frame, and a third lift disposed at a second side of the fourth frame.

In some implementations, the painting system can further include a first driving device configured to elevate the first lift, a second driving device configured to elevate the second lift, and a third driving device configured to elevate the third lift, where the first to third driving devices are configured to respectively elevate the first to third lifts. In some implementations, the painting system can further include a rotation device configured to rotate the third frame, where the rotation device includes a motor.

In some examples, the rail is one of a plurality of rails including a first rail and a second rail that are parallel to each other, where the table is disposed between the first rail and the second rail. In some examples, a separation distance between the first rail and the second rail is greater than 0.7 times a maximum width of an object to be painted by the painting system. In some examples, a maximum extension length of the arm is greater than a half of a separation distance between the first rail and the second rail.

In some implementations, the exhaust port can be one of a plurality of exhaust ports that are defined at the table and arranged in a direction, where the lift is disposed at a first side with respect to the plurality of exhaust ports. In some examples, the rotation device can be disposed at a second side with respect to the plurality of exhaust ports and configured to rotate the table, where the rotation device includes a motor.

In some examples, the spraying device can include a nozzle.

In some examples, each of the first driving device, the second driving device, and the third driving device can include a pinion gear, a rack gear engaged with the pinion gear, and a motor configured to rotate the pinion gear.

In some examples, the table can have a circular shape, and the lift can be disposed at one side with respect to a center of the table. In some examples, the base has linear sides, and the rail extends along one of the linear sides of the base. In some examples, a length of the rail is greater than or equal to a length of the one of the linear sides of the base. In some examples, the rail extends upward relative to an upper surface of the table.

In some implementations, the arm is configured to rotate relative to the table and configured to be positioned at (i) an upper position above an object to be painted on the table and (ii) a lower position below the object based on movement of the lift relative to the table.

In some examples, the exhaust port can include at least one of (i) an annular space between the first frame and the second frame or (ii) an inner space surrounded by the second frame.

In some implementations, the painting system can perform a painting operation through the rotation of a table, the elevation of a lift, and the movement of a robot arm, thereby ensuring painting quality for an aircraft having a complex external structure. In addition, gases, such as harmful substances generated from paint, and dispersed paint particles, can be exhausted through an exhaust port disposed below a table, thereby ensuring the quality of a painted surface and facilitating the treatment of the harmful substances.

The effects of the present disclosure are not limited to those set forth herein, and other effects not set forth herein will be clearly recognized by those skilled in the art from the description below.

### BRIEF DESCRIPTION OF THE DRAWINGS

The above and other aspects, features, and advantages of the present disclosure will be more clearly understood from the following detailed description, taken in conjunction with the accompanying drawings.

FIG. 1 is a schematic diagram illustrating an example of a painting system.

FIG. 2 is another schematic diagram illustrating the painting system.

FIGS. 3A and 3B illustrate an example operation of a lift in the painting system.

FIG. 4 is a schematic diagram illustrating an example of a driving device for elevating the lift.

FIG. 5 is a plan view of the painting system.

FIG. 6 is a diagram illustrating an example of an exhaust mechanism of the painting system.

FIG. 7 is a diagram illustrating an example of a painting system.

FIG. 8 illustrates an example of frames of a table of the painting system in FIG. 7.

### DETAILED DESCRIPTION

Hereinafter, one or more example embodiments of the present disclosure will be described in more detail with reference to the accompanying drawings.

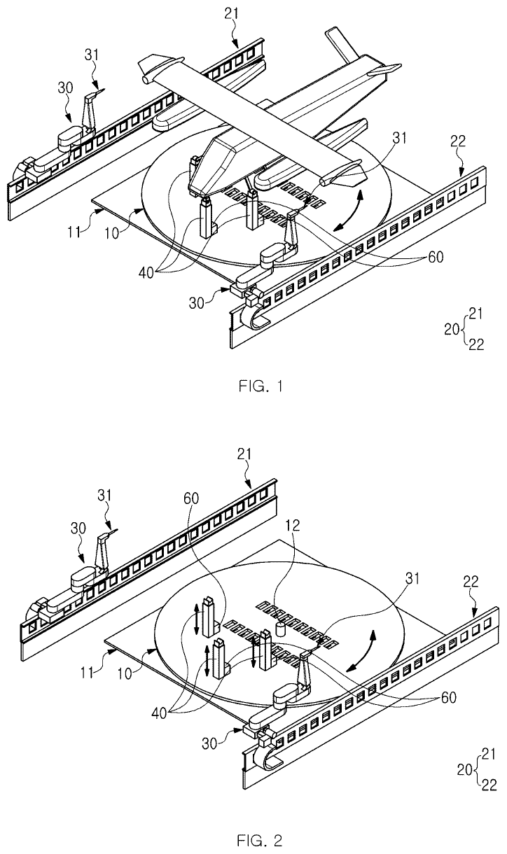

FIG. 1 is a schematic diagram illustrating an example of a painting system. FIG. 2 is another schematic diagram illustrating the painting system.

A painting system according to the present disclosure will be described with reference to FIGS. 1 and 2. In some implementations, the painting system can broadly include a table 10, a rail 20, a robot arm 30, and a lift 40.

For example, the table 10 can be used as a platform for a painting operation, and can have a flat plate structure in which an upper surface thereof is generally disposed to be parallel to the ground. The table 10 can have an approximately circular shape. A base 11 can be disposed below the table 10, and the base 11 can stably support the table 10. A rotation device 12 can be connected to the table 10 and the base 11 to allow the table 10 to rotate relative to the base 11.

The rotation device 12 can include a driving device such as a motor, and the driving device can control the rotation of the table 10. One side of the rotation device 12 can be fixed to the base 11, and the other side of the rotation device 12 can be coupled to the table 10, allowing the table 10 to rotate relative to the base 11. A rotational speed of the table 10 can be adjusted by the rotation device 12, and such rotational speed can be directly set by a user or automatically controlled according to a pre-programmed algorithm. For example, depending on the painting operation, the rotational speed of the table 10 can be set to 30 degrees per second, and can be adjusted to a higher or lower speed. Paint applied to an object to be painted can include a flammable material. Thus, an explosion-proof motor can be used as a motor of the rotation device 12.

The rail 20 can be disposed along a side portion of the table, and can be disposed at a predetermined distance from the table 10. The rail 20 can provide a movement path for a robot arm 30 described below, and the robot arm 30 can be configured to move along the rail 20 in a longitudinal direction of the rail 20. Such a configuration can allow the robot arm 30 to access the entire table. In some examples, the robot arm 30 can include a swing arm configured to rotate relative to the table and configured to be positioned at (i) an upper position above an object to be pained on the table and (ii) a lower position below the object based on movement of the lift relative to the table.

The rail 20 can be provided as a plurality of rails 20, and can include a first rail 21 and a second rail 22. The first rail 21 and the second rail 22 can be spaced apart from each other with the table 10 interposed therebetween, and can be generally disposed to be parallel to each other. The first rail 21 and the second rail 22 can be disposed along both side surfaces of the table 10 to cover a wide area of the table 10. Such an arrangement can expand an operation region, and can provide a structure in which two robot arms can operate independently of each other, thereby improving operation efficiency.

Each of the first rail 21 and the second rail 22 can have a robot arm disposed thereon. With such an arrangement, two robot arms 30 can independently move along the respective rails 20 to perform a painting operation. The robot arm 30 can be movably coupled to the rail 20. For example, a roller or a slider can be disposed between the rail 20 and the robot arm 30, and the roller or the slider can minimize or reduce friction.

The robot arms 30 can be disposed on the first rail 21 and the second rail 22, respectively, and the robot arms 30 disposed on the first rail 21 and the second rail 22 can have the same structure. The robot arm 30 can have multiple joints and provide multiple degrees of freedom, allowing the paint to be sprayed at various angles and in various directions. The multi-joint structure can be designed such that respective joints are rotatable and movable independently, enabling a painting operation even on an object to be painted having complex shapes or curved surfaces. In addition, the joints of the robot arm 30 can be driven by a servo motor or a hydraulic system.

A spraying device 31 for spraying paint can be attached to an end of the robot arm. For example, the spraying device 31 can include one or more spray nozzles. In some implementations, the spraying device 31 can be provided such that the number of nozzles, spraying angle, and spraying pressure are adjustable.

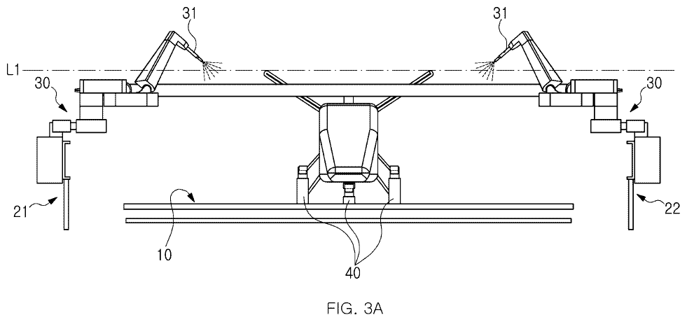

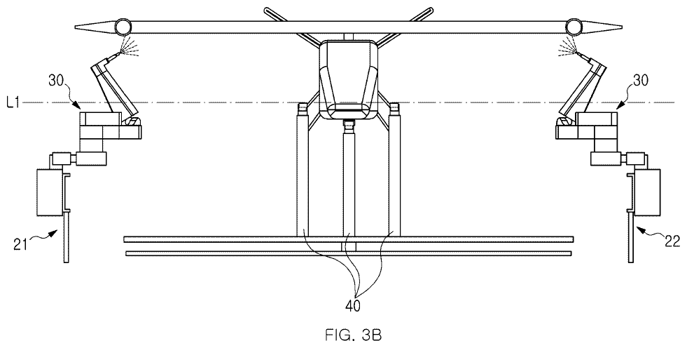

FIGS. 3A and 3B illustrate an example operation of a lift in the painting system. The driving of a lift and a painting operation of a robot arm according to the driving of the lift will be described with reference to FIGS. 3A and 3B.

The painting operation can be performed through paint spraying, and a direction of paint spraying performed by robot arm 30 can be adjusted in various manners. For ease of description, a spraying direction from an upper side to a lower side of an object to be painted can be referred to as a first direction, and a spraying direction from the lower side to the upper side of the object to be painted can be referred to as a second direction.

In order to spray paint in the first direction, a painting surface of the object to be painted can be positioned below a spraying device mounted on the robot arm 30. For example, as illustrated in FIG. 3A, a lift 40 can descend relative to a reference line L1 to downwardly move a position of the object to be painted. For example, the reference line L1 can refer to an initial position of the lift. That is, the lift can be disposed at a preset reference position (height) before ascending or descending, and the reference line L1 can refer to a reference height.

As the lift 40 descends, the object to be painted can be positioned below the spraying device 31 of the robot arm 30, and the robot arm 30 can spray paint in the first direction to perform the painting operation.

In some examples, in order to spray paint in the second direction, the painting surface of the object to be painted can be positioned above the spraying device. For example, as illustrated in FIG. 3B, the lift 40 can ascend relative to the reference line L1 to upwardly move a position of the painting surface of the object to be painted. As the lift 40 ascends, the painting surface of the object to be painted can be positioned above the spraying device 31 of the robot arm 30. In this case, the robot arm 30 sprays paint in the second direction to perform the painting operation.

A height of the object to be painted can be adjusted through the lift 40 to perform the painting operation, thereby effectively preventing interference between the robot arm 30 and the object to be painted during the painting operation. The lift 40 can adjust the position of the object to be painted, such that the robot arm 30 can perform the painting operation at various angles and in various directions.

Ascending and descending ranges of the object to be painted through the lift 40 can be limited within a preset range. The ranges can be set in consideration of operation safety, an operating range of the robot arm 30, a size of the object to be painted, or the like. The ascending range of the lift 40 can be set to be greater than the descending range of the lift 40. For example, the ascending range of the object to be painted through the lift 40 can be set to 1000 mm or less, and the descending range of the object to be painted through the lift 40 can be set to 500 mm or less. Such settings can allow for uniform painting of the object to be painted and minimize or reduce physical interference between the robot arm 30 and the object to be painted during the painting operation. In addition, the object to be painted can be moved to a target position, enabling adaptation to various painting operation environments.

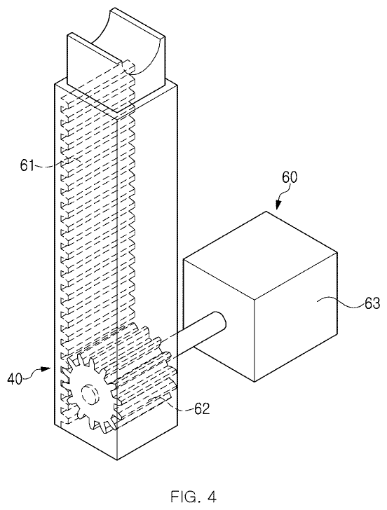

FIG. 4 is a schematic diagram illustrating an example of a driving device for elevating the lift.

A driving device 60 can include a gear 62 (e.g., a pinion gear). A lift 40 can have a rack gear 61. The gear 62 of the driving device 60 can be engaged with the rack gear 61 of the lift 40. As the gear 62 of the driving device 60 rotates, the lift 40 can ascend or descend. The driving device 60 can include a motor 63, and the motor 63 can be coupled to the gear 62 of the driving device 60. The driving device 60 can be disposed in a cover portion. The cover portion can prevent the driving device from being contaminated by paint.

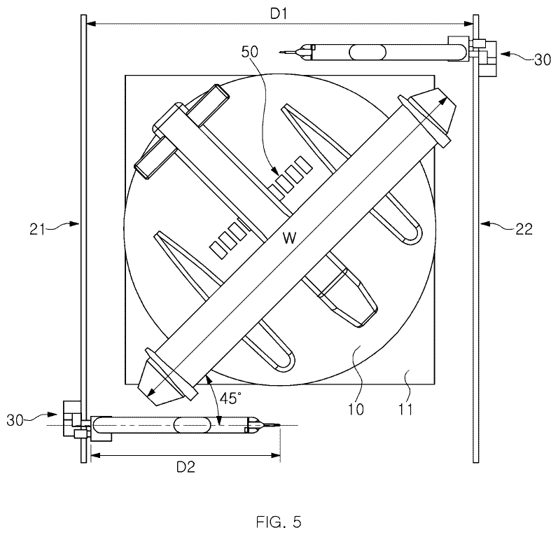

FIG. 5 is a plan view of a painting system. Referring to FIG. 4, a first rail 21 and a second rail 22 have a separation distance D1 therebetween. When an object to be painted is an aircraft, a distance from one end of a wing to the other end of the wing can be a maximum width W of the object to be painted.

The separation distance D1 can be determined by the maximum width W of the object to be painted. Specifically, when a painting surface of the object to be painted and the rail 20 are disposed to overlap each other in a direction, perpendicular to the ground, due to rotation of the table 10, a portion of paint sprayed from a spraying device 31 can fall onto the rail, contaminating the rail with paint.

Accordingly, when the object to be painted rotates, the separation distance D1 can be determined within a range that allows the painting operation to be performed at a position at which the painting surface and the rail 20 do not sequentially overlap each other in the direction, perpendicular to the ground.

In FIG. 5, when a direction of the maximum width W of the object to be painted is the same as a separation direction of the separation distance D1, and the object to be painted rotates by 45 degrees, the separation distance D1 can be determined. That is, the separation distance D1 can satisfy Equation 1.

$$D 1 > \frac{W}{\sqrt{2}} \qquad [ Equation 1 ]$$

In other words, the separation distance D1 between the first rail 21 and the second rail 22 can be greater than approximately 0.7 times the maximum width of the object to be painted.

In addition, in FIG. 5, a maximum extension length D2 of the robot arm 30 can also be determined, and the maximum extension length D2 of the robot arm 30 can satisfy Equation 2.

$$D 2 > \frac{D 1}{2} \qquad [ Equation 2 ]$$

In other words, the maximum extension length D2 of the robot arm 30 can have a value greater than a half of the separation distance D1 between the first rail 21 and the second rail 22.

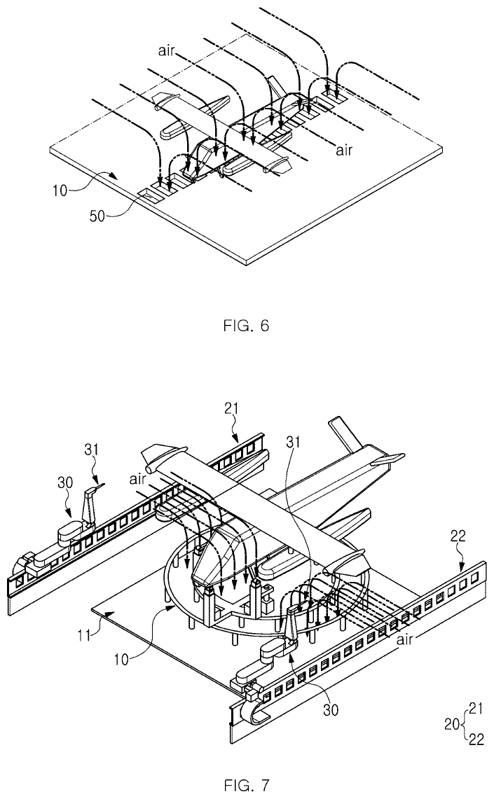

FIG. 6 is a diagram illustrating an example of an exhaust mechanism of a painting system.

An exhaust port 50 can be disposed on the table 10. Through the exhaust port 50, the air above the table 10 can be transferred below the table 10. A flow of air passing through the exhaust port 50 can be generated by a fan. In some examples, the fan can rotate at a constant speed to maintain the flow of air, and can adjust a volume of air flow by adjusting a speed thereof. A size and shape of the fan can be appropriately designed according to a size and structure of the table 10, and a rotational direction and speed of the fan can be adjusted in consideration of an exhaust effect.

When the air above the table 10 flows downwardly through the exhaust port 50, gases generated from paint or paint particles dispersed in the air can move below the table through the exhaust port 50 along with the flow of air. The gases or paint particles transferred below the table 10 through the exhaust port 50 can be processed by a treatment device.

The exhaust port 50 can be provided as a plurality of exhaust ports 50. In some examples, a cover can be disposed on the exhaust port 50. The cover can, for example, be a cover having a grid-structured hole. The cover can block foreign substances from being introduced into the exhaust port 50 while maintaining a smooth flow of air. The cover can also effectively block foreign substances, and can be configured to be detachable from the exhaust port 50.

In addition, the exhaust port 50 can include a filter device. The filter device can capture fine paint particles or harmful substances in the air introduced through the exhaust port 50. The filter device can have a multilayer structure. Respective layers can effectively remove particles having different sizes.

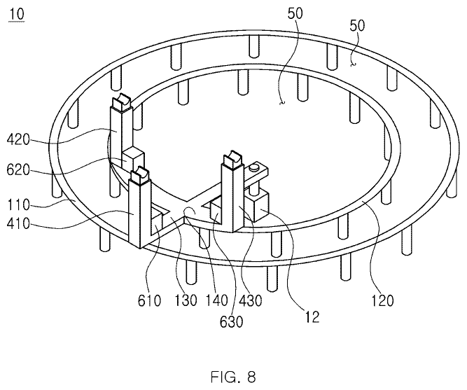

FIG. 7 is a diagram illustrating an example of a painting system, and FIG. 8 illustrates an example of frames of a table of the painting system shown in FIG. 7. The painting system is described with reference to FIGS. 7 and 8. Hereinafter, a description the same as the above description of the painting system provided with reference to FIGS. 1 to 6 can be omitted.

The table 10 can have a frame structure. The table 10 can include a first frame 110, a second frame 120, a third frame 130, and a fourth frame 140.

The first frame 110 can have a ring structure. The second frame 120 can have a ring structure. A diameter of the first frame 110 can be greater than a diameter of the second frame 120. Centers of circles of the first frame 110 and the second frame 120 can be disposed at the same position.

The first frame 110 and the second frame 120 can have ring structures, and thus can be spaced apart from each other in a radial direction of the first frame 110 or the second frame 120. Accordingly, a space can be formed between the first frame 110 and the second frame 120, and the space between the first frame 110 and the second frame 120 can be an exhaust port 50. In addition, since the second frame has a ring structure, the second frame can also have an internal space in the radial direction, and the internal space in the radial direction of the second frame can also be the exhaust port 50. Through the exhaust port, air can flow from an upper side to a lower side of the table, and gases and dispersed paint particles can flow from the upper side to the lower side of the table along with the flowing air. That is, the exhaust port 50 can include an annular space between the first frame 110 and the second frame 120 and an inner space surrounded by the second frame 120.

The third frame 130 can have a bar structure. The third frame 130 can rotate in a state of being supported by the first frame 110 and the second frame 120. A first lift 410 can be disposed on one side of the third frame 130. A rotation device 12 can be disposed on the other side of the third frame 130. The rotation device 12 can rotate the third frame 130. For example, the rotation device 12 can include an explosion-proof motor. Through the rotation device 12, the third frame 130 can rotate in a circumferential direction of the first frame 110 or the second frame 120. In some examples, the rotation device 12 (e.g., a motor) can be disposed at a center of the first and second frames.

The fourth frame 140 can be coupled to the third frame 130, and can rotate together with the third frame 130. A second lift 420 and a third lift 430 can be disposed on one side and the other side of the fourth frame 140, respectively.

A first driving device 610 for lifting the first lift 410 can be disposed on one side of the third frame 130. A second driving device 620 for lifting the second lift 420 can be disposed on one side of the fourth frame 140. A third driving device 630 for lifting the third lift 430 can be disposed on the other side of the fourth frame 140. That is, the first lift 410, the second lift 420, and the third lift 430 can respectively have separate driving devices, and thus can be respectively elevated. The first driving device 610, the second driving device 620, and the third driving device 630 can respectively include explosion-proof motors, and can respectively elevate the first lift 410, the second lift 420, and the third lift 430, through rack gears. In addition, a cover can be provided on the outside of each of the first driving device 610, the second driving device 620, and the third driving device 630. The cover can prevent contamination of the first driving device 610, the second driving device 620, and the third driving device 630 caused by paint or the like.

While example embodiments have been shown and described above, it will be apparent to those skilled in the art that modifications and variations could be made without departing from the scope of the present disclosure as defined by the appended claims.

What is claimed is:

1. A painting system comprising:
a table configured to rotate relative to a base;
a rail spaced apart from the table;
an arm configured to move along the rail;
a spraying device disposed at the arm; and
a lift disposed at the table and configured to be elevated from the table,
wherein the table defines an exhaust port configured to draw air from an upper side of the table to a lower side of the table.

2. The painting system of claim 1, wherein the table comprises:
a first frame; and
a second frame spaced apart from the first frame in a radial direction of the first frame, the second frame being disposed radially inside the first frame.

3. The painting system of claim 2, wherein each of the first frame and the second frame has a ring structure.

4. The painting system of claim 2, wherein the table further comprises:
a third frame disposed at the first frame, the third frame configured to rotate relative to the first frame in a circumferential direction of the first frame; and
a fourth frame coupled to the third frame and configured to rotate relative to the second frame in a circumferential direction of the second frame.

5. The painting system of claim 4, wherein the lift is one of a plurality of lifts comprising:
a first lift disposed at the third frame;
a second lift disposed at a first side of the fourth frame; and
a third lift disposed at a second side of the fourth frame.

6. The painting system of claim 5, further comprising:
a first driving device configured to elevate the first lift;
a second driving device configured to elevate the second lift; and
a third driving device configured to elevate the third lift, and
wherein the first to third driving devices are configured to respectively elevate the first to third lifts.

7. The painting system of claim 4, further comprising:
a rotation device configured to rotate the third frame, the rotation device comprising a motor.

8. The painting system of claim 1, wherein the rail is one of a plurality of rails comprising a first rail and a second rail that are parallel to each other,
wherein the table is disposed between the first rail and the second rail.

9. The painting system of claim 8, wherein a separation distance between the first rail and the second rail is greater than 0.7 times a maximum width of an object to be painted by the painting system.

10. The painting system of claim 8, wherein a maximum extension length of the arm is greater than a half of a separation distance between the first rail and the second rail.

11. The painting system of claim 1, wherein the exhaust port is one of a plurality of exhaust ports that are defined at the table and arranged in a direction, and
wherein the lift is disposed at a first side with respect to the plurality of exhaust ports.

12. The painting system of claim 11, comprising:
a rotation device disposed at a second side with respect to the plurality of exhaust ports and configured to rotate the table, the rotation device comprising a motor.

13. The painting system of claim 1, wherein the spraying device comprises a nozzle.

14. The painting system of claim 6, wherein each of the first driving device, the second driving device, and the third driving device comprises:
a pinion gear;
a rack gear engaged with the pinion gear; and
a motor configured to rotate the pinion gear.

15. The painting system of claim 1, wherein the table has a circular shape, and the lift is disposed at one side with respect to a center of the table.

16. The painting system of claim 1, wherein the base has linear sides, and the rail extends along one of the linear sides of the base.

17. The painting system of claim 16, wherein a length of the rail is greater than or equal to a length of the one of the linear sides of the base.

18. The painting system of claim 17, wherein the rail extends upward relative to an upper surface of the table.

19. The painting system of claim 1, wherein the arm is configured to rotate relative to the table and configured to be positioned at (i) an upper position above an object to be painted on the table and (ii) a lower position below the object based on movement of the lift relative to the table.

20. The painting system of claim 2, wherein the exhaust port comprises at least one of (i) an annular space between the first frame and the second frame or (ii) an inner space surrounded by the second frame.
